(19) United States
(12) Patent Application Publication
(10) Pub. No.: US 2016/0123073 A1
(43) Pub. Date: May 5, 2016

(54) BLIND BODY POSITIONING MECHANISM FOR NON PULL CORD WINDOW BLIND AND WINDOW BLIND USING THE SAME

(71) Applicant: Chin-Fu Chen, Taichung City (TW)

(72) Inventor: Po-Yu CHEN, Taichung City (TW)

(21) Appl. No.: 14/533,607

(22) Filed: Nov. 5, 2014

(51) Int. Cl. E06B 9/34

(52) U.S. Cl. CPC E06B 9/34

(57) ABSTRACT

A window body positioning mechanism of a non pull cord window blind includes a transmission unit including two first transmission wheels meshed together, a coil spring connected between the first transmission wheels and wound round one first transmission wheel, two second transmission wheels respectively meshed with one respective first transmission wheel, and two transmission cords each having one end thereof fixedly connected to one respective second transmission wheel and being wound round the respective second transmission wheel upon its rotation, and a damper unit including a damper and a reel connected to the damper and wound round by one transmission cord in such a manner that when the blind body is being extended out or received, the damper imparts a damping resistance to the transmission cords through the reel to achieve excellent positioning effects.

### BACKGROUND OF THE INVENTION

1. Field of the Invention

The present invention relates to window blind technology, and more particularly to a blind body positioning mechanism for non pull cord window blind and a non pull cord window using the blind body positioning mechanism.

2. Description of the Related Art

Commercial window blinds can be classified into pull-cord window blinds and non pull cord window blinds. A pull-cord window blind uses a pull cord for pulling by a user to move the blind between an extended status and a received status. A non pull cord window blind allows a user to pull down or lift the bottom rail, causing the blind to be moved between an extended status and a received status.

Although a non pull cord blind allows users to easily extend out or receive the blind body, the blind body is prone to rebounding after fully extended out, or sagging after fully received, due to lack of good positioning design in the structural configuration, bringing trouble to the user in actual operation.

### SUMMARY OF THE INVENTION

The present invention has been accomplished under the circumstances in view. It is the main object of the present invention to provide a blind body positioning mechanism for non pull cord window blind, which has a simple structure and provides excellent positioning effects, enhancing operating convenience.

To achieve this and other objects of the present invention, a blind body positioning mechanism comprises a transmission unit and a damper unit. The transmission unit comprises a casing, two first transmission wheels, a coil spring, two second transmission wheels, and at least two transmission cords. The two first transmission wheels are rotatably mounted in the casing and meshed with each other. The coil spring is connected between the two first transmission wheels and selectively wound round one first transmission wheel. The two second transmission wheels are rotatably mounted in the casing and respectively meshed with one respective first transmission wheel. Each transmission cord has one end thereof fixedly connected to one respective second transmission wheel, and is wound round the respective second transmission wheel during rotation of the respective second transmission wheel. The damper unit comprises a reel holder, a damper, and a reel. The damper comprises an oil reservoir and a brake gear. The oil reservoir is fixedly mounted in the reel holder. The brake gear is pivotally mounted on the oil reservoir. The reel is wound with one transmission cord. The reel has one end thereof pivotally connected to the reel holder, and an opposite end thereof provided with a toothed coupling hole for engagement with the brake gear of the damper.

Thus, when the transmission cords are stretched by an external force, they will synchronously drive the reel to rotate. During rotation of the reel, the brake gear of the damper imparts a damping resistance to the reel through the damping oil in the oil reservoir. This damping resistance will become in static balance with the elastic restoring force of the coil spring as the external force disappears, providing the blind body with a good positioning effect.

Preferably, each first transmission wheel comprises a first transmission sprocket, and a first transmission shaft fixedly connected with the first transmission sprocket. The coil spring is connected between the first transmission wheel shafts of the two first transmission wheels, and selectively wound round the first transmission wheel shaft of one first transmission wheel. Each second transmission wheel comprises a second transmission sprocket, and a second transmission wheel shaft fixedly connected with the second transmission sprocket. The second transmission sprocket is meshed with the first transmission sprocket of one respective first transmission wheel. Each transmission cord has one end thereof fixedly connected to the second transmission wheel shaft of one respective second transmission wheel.

Preferably, the reel holder comprises two opposing upright side panels, a pivot hole located on one upright side panel, and a mounting slot located on the other upright side panel. The reel has one end thereof pivotally coupled to the pivot hole of the reel holder. The oil reservoir is fixedly mounted in the mounting slot of the reel holder. The brake gear is disposed outside the mounting slot.

A non pull cord window blind using the aforesaid blind body positioning mechanism in accordance with the present invention comprises a top rail, a bottom rail spaced below the top rail, and a blind body coupled between the top rail and the bottom rail. The casing of the blind body positioning mechanism is mounted in the bottom rail. The reel holder of the damper unit of the blind body positioning mechanism is mounted in the bottom rail. Each transmission cord of the blind body positioning mechanism has an opposite end thereof inserted through the blind body and connected to the top rail. Thus, the transmission cords can be stretched when the bottom rail is pulled down.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a non pull cord window blind in accordance with the present invention.

FIG. 2 is an exploded view of the transmission unit of the non pull cord window blind in accordance with the present invention.

FIG. 3 is an exploded view of the damper unit of the non pull cord window blind in accordance with the present invention.

FIG. 4 is a schematic plain view of the present invention, illustrating a status of the non pull cord window blind after the transmission cords of the blind body positioning mechanism having been stretched.

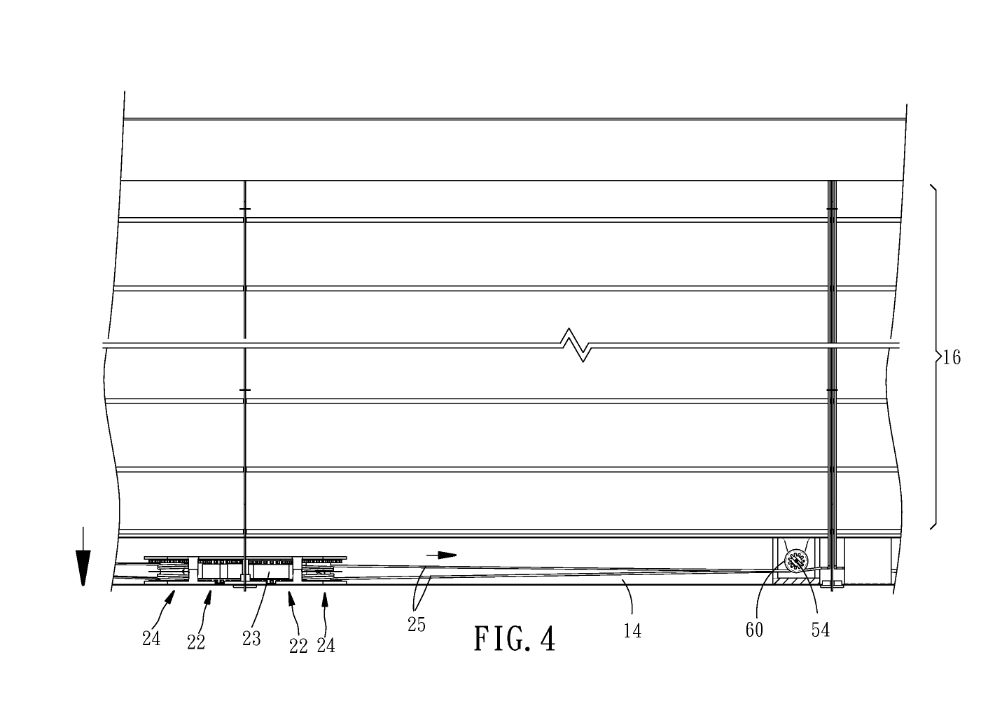

FIG. 5 is similar to FIG. 4, illustrating a status of the non pull cord window blind after the transmission cords of the blind body positioning mechanism having been rolled up.

FIG. 6 is similar to FIG. 1, illustrating the blind body in the received status.

### DETAILED DESCRIPTION OF THE INVENTION

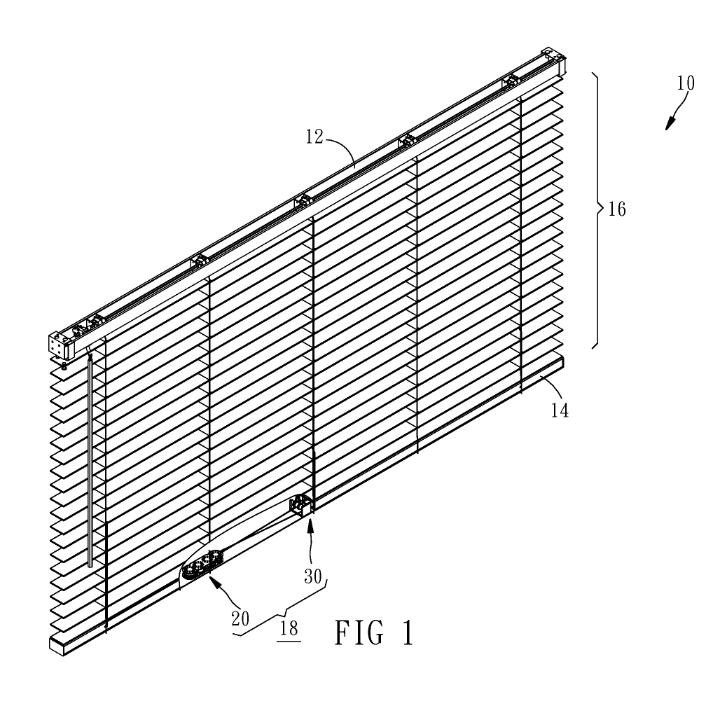

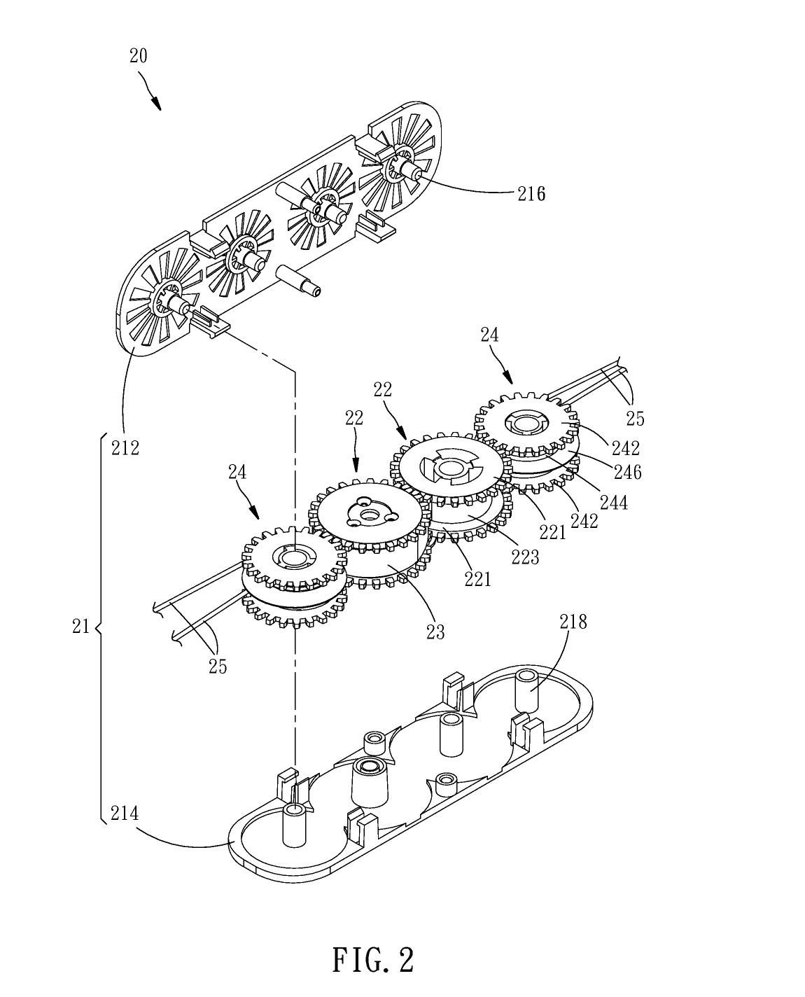

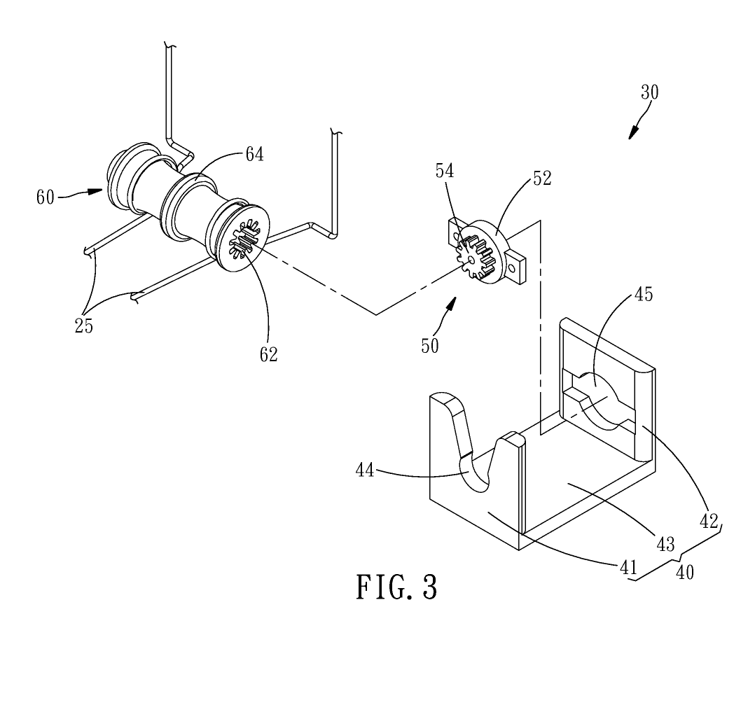

Referring to FIG. 1, a non pull cord window blind 10 in accordance with the present invention is shown. As illustrated, the non pull cord window blind 10 comprises a top rail 12, an opposing bottom rail 14, and blind body 16 coupled between the top rail 12 and the bottom rail 14. Referring also to FIG. 2 and FIG. 3, a blind body positioning mechanism 18 in accordance with the present invention is shown used in the aforesaid non pull cord window blind 10, comprising a transmission unit 20 and a damper unit 30.

The transmission unit 20 comprises a casing 21, two first transmission wheels 22, a coil spring 23, two second transmission wheels 24, and two pairs of transmission cords 25.

Each first transmission wheel 22 comprises two first transmission sprockets 221 (actually, one single transmission sprocket can achieve the same effect), and a first transmission wheel shaft 223 connected between the two first transmission sprockets 221. During installation, the first transmission wheel shaft 223 is rotatably coupled between a respective top pivot pin 216 at a top locating plate 212 of the casing 21 and a respective bottom pivot pin 218 at a bottom locating plate 214 of the casing 21. After installation, the first transmission sprockets 221 of the first transmission wheels 22 are meshed together.

The coil spring 23 connects the first transmission wheel shafts 223 of the two first transmission wheels 22, and is wound round the first transmission wheel shaft 223 of one first transmission wheel 22 during relative rotation between the two first transmission wheels 22.

Each second transmission wheel 24 comprises two second transmission sprockets 242, and a second transmission wheel shaft 244 connected between the two second transmission sprockets 242. During installation, the second transmission wheel shaft 244 is rotatably coupled between a respective top pivot pin 216 at the top locating plate 212 of the casing 21 and a respective bottom pivot pin 218 at the bottom locating plate 214 of the casing 21. After installation, the second transmission sprockets 242 of the second transmission wheels 24 are respectively meshed with the first transmission sprockets 221 of the first transmission wheels 22. Thus, the first transmission wheels 22 and the second transmission wheels 24 can be rotated synchronously.

Each pair of transmission cords 25 have respective one ends thereof fixedly connected to the second transmission wheel shafts 244 of one respective second transmission wheel 24, and respective opposite ends thereof inserted through the blind body 16 and fixedly connected to the top rail 12. To prevent the two transmission cords 25 from being tangled with each other during rotation of the second transmission wheel 24, the second transmission wheel shaft 244 of each second transmission wheel 24 is configured to provide an annular isolating rib 246 that extends around the second transmission wheel shaft 244 on the middle to keep the two transmission cords 25 apart.

Referring to FIG. 3 again, the damper unit 30 comprises a reel holder 40, a damper 50, and a reel 60.

The reel holder 40 is fixedly mounted in the bottom rail 14, comprising two opposing upright side panels 41 and 42, a horizontal bottom panel 43 connected between the two upright side panels 41 and 42, a pivot hole 44 located in one upright side panel 41, and a mounting slot 45 located in the other upright side panel 42.

The damper 50 comprises an oil reservoir 52 and a brake gear 54. The oil reservoir 52 is fixedly mounted in the mounting slot 45 of the reel holder 40 for storing a high viscosity damping oil. The brake gear 54 is pivotally mounted on the oil reservoir 52 and disposed outside the mounting slot 45 of the reel holder 40.

The reel 60 has one end thereof pivotally mounted in the pivot hole 44 of the reel holder 40, and an opposite end thereof provided with a toothed coupling hole 62. The toothed coupling hole 62 of the reel 60 can be engaged with the brake gear 54 of the damper 50, enabling the reel 60 to be synchronously rotated with the brake gear 54. Further, the reel 60 is wound round by one pair of transmission cords 25.

To prevent these two transmission cords 25 from being tangled with each other during rotation of the reel 60, the reel 60 is configured to provide an isolating flange 64 that extends around the periphery of the reel 60 on the middle to keep the two transmission cords 25 apart.

From the structure stated above, it can be known that when wishing to extend out the blind body 16, pull the bottom rail 14 downwards to stretch the transmission cords 25. When the transmission cords 25 are being stretched, on the one hand, the second transmission wheels 24 are rotated by the transmission cords 25, causing the first transmission wheels 22 to be respectively rotated by the second transmission wheels 24. At this time, the coil spring 23 is rolled up from one first transmission wheel 22 onto the other transmission wheel 22 to accumulate an elastic restoring force. On the other hand, the reel 60 is driven by the transmission cords 25 to rotate the brake gear 54 to the extent where the blind body 16 is fully extended out and the user releases the pulling force from the bottom rail 14. At this time, the damping oil in the oil reservoir 52 imparts a damping resistance to the reel 60 that will be in static balance with the elastic restoring force of the coil spring 23 to prohibit the transmission cords 25 from being rolled up by the respective second transmission wheels 24, and thus, the blind body 16 is accurately held in the extended position, as shown in FIG. 1.

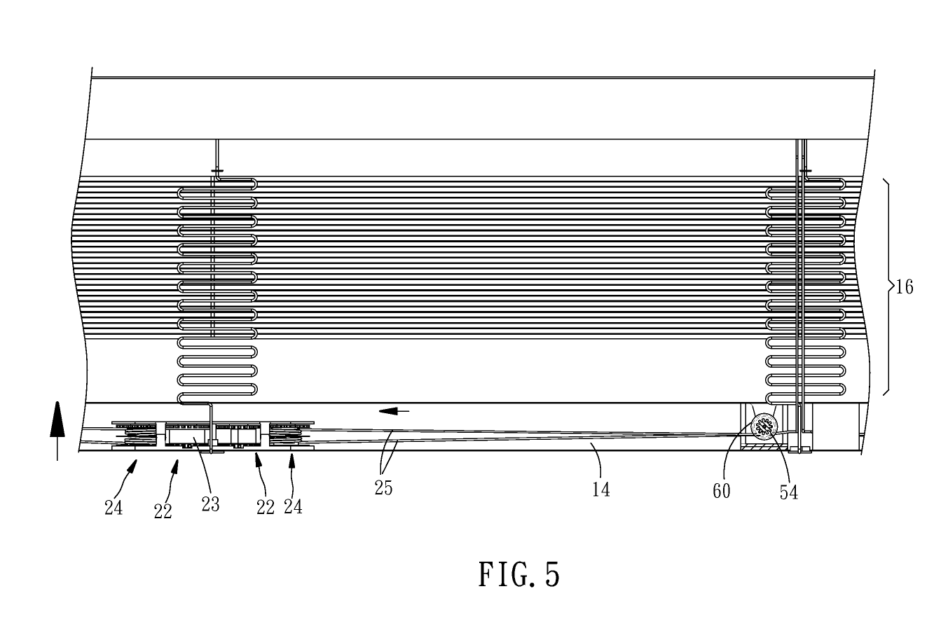

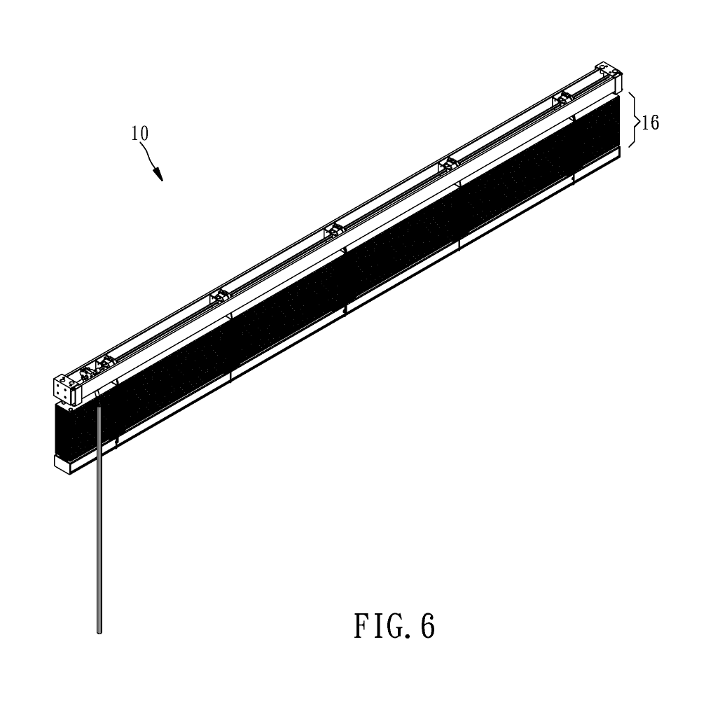

When wishing to receive the blind body 16, push the bottom rail 14 upwards. At this time, as shown in FIG. 5, the elastic restoring force of the coil spring 23 assists the user's push force to overcome the damping resistance being given by the damping oil in the oil reservoir 52 to the reel 60 through the brake gear 54. At this time, the first transmission wheels 22 are reversed, thereby rotating the second transmission wheels 24 to roll up the respective transmission cords 25 and to further lift the blind body 16. The user can then releases the push force from the bottom rail 14 after the blind body 16 is fully received. At this time, the elastic restoring force of the coil spring 23 becomes in static balance with the damping resistance of the damping oil, and thus, the blind body 16 is accurately held in the received position, as shown in FIG. 6.

In conclusion, the blind body positioning mechanism 18 of the invention utilizes the damping resistance of the damper 50 to provide the blind body 16 with a good positioning effect, eliminating the problem of rebounding after fully extended out or sagging after fully received, and enhancing operating convenience.

What is claimed is:

1. A blind body positioning mechanism used in a non pull cord window blind, comprising:
a transmission unit comprising a casing, two first transmission wheels, a coil spring, two second transmission wheels and at least two transmission cords, said two first transmission wheels being rotatably mounted in said casing and meshed with each other, said coil spring being connected between said two first transmission wheels and selectively wound round one said first transmission wheel, said two second transmission wheels being rotatably mounted in said casing and respectively meshed with one respective said first transmission wheel, each said transmission cord having one end thereof fixedly connected to one respective said second transmission wheel and being wound round the respective said second transmission wheel during rotation of the respective said second transmission wheel; and
a damper unit comprising a reel holder, a damper and a reel, said damper comprising an oil reservoir and a brake gear, said oil reservoir being fixedly mounted in said reel holder, said brake gear being pivotally mounted on said oil reservoir, said reel being wound with one said transmission cord, said reel having one end thereof pivotally connected to said reel holder and an opposite end thereof provided with a toothed coupling hole, said toothed coupling hole being engaged with said brake gear of said damper.

2. The blind body positioning mechanism as claimed in claim 1, wherein each said first transmission wheel comprises a first transmission sprocket and a first transmission shaft fixedly connected with said first transmission sprocket; said coil spring being connected between the first transmission wheel shafts of said two first transmission wheels and selectively wound round the first transmission wheel shaft of one said first transmission wheel; each said second transmission wheel comprises a second transmission sprocket and a second transmission wheel shaft fixedly connected with said second transmission sprocket, said second transmission sprocket being meshed with the first transmission sprocket of one respective said first transmission wheel; each said transmission cord has one end thereof fixedly connected to the second transmission wheel shaft of one respective said second transmission wheel.

3. The blind body positioning mechanism as claimed in claim 2, wherein the number of said transmission cords is 4, and these four transmission cords are arranged in two pairs and respectively connected to the second transmission wheel shaft of one respective said second transmission wheel, and said two pairs of transmission cords respectively wound round one respective said reel; the second transmission wheel shaft of each said second transmission wheel comprises an annular isolating rib extending around the periphery thereof on the middle to keep the respective two said transmission cords apart; said reel comprises an isolating flange extending around the periphery thereof for separating said transmission cords.

4. The blind body positioning mechanism as claimed in claim 2, wherein said casing comprises a top locating plate and a bottom locating plate, said top locating plate comprising four top pivot pins respectively downwardly inserted into the first transmission wheel shafts of said first transmission wheels and the second transmission wheel shafts of said second transmission wheels, said bottom locating plate comprising four bottom pivot pins respectively upwardly inserted into the first transmission wheel shafts of said first transmission wheels and the second transmission wheel shafts of said second transmission wheels.

5. The blind body positioning mechanism as claimed in claim 3, wherein said casing comprises a top locating plate and a bottom locating plate, said top locating plate comprising four top pivot pins respectively downwardly inserted into the first transmission wheel shafts of said first transmission wheels and the second transmission wheel shafts of said second transmission wheels, said bottom locating plate comprising four bottom pivot pins respectively upwardly inserted into the first transmission wheel shafts of said first transmission wheels and the second transmission wheel shafts of said second transmission wheels.

6. The blind body positioning mechanism as claimed in claim 1, wherein said reel holder comprises two opposing upright side panels, a pivot hole located on one said upright side panel, and a mounting slot located on the other said upright side panel; said reel has one end thereof pivotally coupled to said pivot hole of said reel holder; said oil reservoir is fixedly mounted in said mounting slot of said reel holder; said brake gear is disposed outside said mounting slot.

7. A non pull cord window blind, comprising:
a top rail;
a bottom rail spaced below said top rail;
a blind body coupled between said top rail and said bottom rail; and
a blind body positioning mechanism as claimed in claim 1, said casing of said blind body positioning mechanism being mounted in said bottom rail, each said transmission cord of said blind body positioning mechanism having an opposite end thereof inserted through said blind body and connected to said top rail, said reel holder being mounted in said bottom rail.

8. The non pull cord window blind as claimed in claim 7, wherein each said first transmission wheel comprises a first transmission sprocket and a first transmission shaft fixedly connected with said first transmission sprocket; said coil spring being connected between the first transmission wheel shafts of said two first transmission wheels and selectively wound round the first transmission wheel shaft of one said first transmission wheel; each said second transmission wheel comprises a second transmission sprocket and a second transmission wheel shaft fixedly connected with said second transmission sprocket, said second transmission sprocket being meshed with the first transmission sprocket of one respective said first transmission wheel;
each said transmission cord has one end thereof fixedly connected to the second transmission wheel shaft of one respective said second transmission wheel.

9. The non pull cord window blind as claimed in claim 8, wherein the number of said transmission cords is 4, and these four transmission cords are arranged in two pairs and respectively connected to the second transmission wheel shaft of one respective said second transmission wheel, and said two pairs of transmission cords respectively wound round one respective said reel; the second transmission wheel shaft of each said second transmission wheel comprises an annular isolating rib extending around the periphery thereof on the middle to keep the respective two said transmission cords apart; said reel comprises an isolating flange extending around the periphery thereof for separating said transmission cords.

10. The non pull cord window blind as claimed in claim 8, wherein said casing comprises a top locating plate and a bottom locating plate, said top locating plate comprising four top pivot pins respectively downwardly inserted into the first transmission wheel shafts of said first transmission wheels and the second transmission wheel shafts of said second transmission wheels, said bottom locating plate comprising four bottom pivot pins respectively upwardly inserted into the first transmission wheel shafts of said first transmission wheels and the second transmission wheel shafts of said second transmission wheels.

11. The non pull cord window blind as claimed in claim 9, wherein said casing comprises a top locating plate and a bottom locating plate, said top locating plate comprising four top pivot pins respectively downwardly inserted into the first transmission wheel shafts of said first transmission wheels and the second transmission wheel shafts of said second transmission wheels, said bottom locating plate comprising four bottom pivot pins respectively upwardly inserted into the first transmission wheel shafts of said first transmission wheels and the second transmission wheel shafts of said second transmission wheels.

12. The blind body positioning mechanism as claimed in claim 7, wherein said reel holder comprises two opposing upright side panels, a pivot hole located on one said upright side panel, and a mounting slot located on the other said upright side panel; said reel has one end thereof pivotally coupled to said pivot hole of said reel holder; said oil reservoir is fixedly mounted in said mounting slot of said reel holder; said brake gear is disposed outside said mounting slot.
